(19) United States
(12) Patent Application Publication
(10) Pub. No.: US 2026/0032370 A1
(43) Pub. Date: Jan. 29, 2026

(54) SPEAKER

(71) Applicant: AAC Microtech (Changzhou) Co., Ltd., Changzhou City (CN)

(72) Inventor: Chao Zhang, Changzhou (CN)

(21) Appl. No.: 19/006,275

(22) Filed: Dec. 31, 2024

Related U.S. Application Data
(63) Continuation of application No. PCT/CN2024/107193, filed on Jul. 24, 2024.

(51) Int. Cl. H04R 1/06; H04R 7/18; H04R 9/02; H04R 9/06

(52) U.S. Cl. CPC H04R 1/06; H04R 7/18; H04R 9/025; H04R 9/063; H04R 2400/11

(57) ABSTRACT

A speaker includes a frame, a vibration system fixed with the frame, and a magnetic circuit system driving the vibration system to vibrate and sound. The vibration system includes a diaphragm fixed with the frame, at least two voice coils driving the diaphragm to vibrate and sound, and a conductive member. The at least two voice coils are connected to each other via a conductive gel and/or the at least two voice coils are connected to the conductive member via the conductive gel, the conductive gel is affixed to the diaphragm, and an insulating coating is located between the conductive gel and the diaphragm. Compared with the related art, the stability of the electrical connection of the at least two voice coils could be enhanced, and the acoustic performance of the speaker could also be improved.

### FIELD OF THE INVENTION

The invention relates to the technical field of acoustic technology, in particular to speaker.

### BACKGROUND

In the related art, a speaker includes a frame, a vibration system fixed with the frame, and a magnetic circuit system with a magnetic gap, the vibration system includes a diaphragm and a voice coil. The voice coil is connected to an external circuit via a flexible circuit board (FPC). The voice coil drives the diaphragm to vibrate and produce sound via a magnetic field. In order to improve the performance of the speaker, the BL value (i.e., the magnetic force value which is the product of the magnetic flux density B and the voice coil line length L) and sensitivity of the product could be prioritized enhanced by setting multiple voice coils, however, the connection between the multiple voice coils is through voice coil wires and the FPC. In this case, the voice coil wires are too long and easy to break, and the FPC will take up more space which will affect the volume of the magnetic circuit, thus affecting the performance of the speaker.

Therefore, it is desired to provide an improved speaker to solve the above problems.

### SUMMARY

In one aspect, the present disclosure provides a speaker including a frame, a vibration system fixed with the frame, and a magnetic circuit system driving the vibration system to vibrate and sound. The vibration system includes a diaphragm fixed with the frame, at least two voice coils driving the diaphragm to vibrate and sound, and a conductive member. The at least two voice coils are connected to each other via a conductive gel and/or the at least two voice coils are connected to the conductive member via the conductive gel, the conductive gel is affixed to the diaphragm, and an insulating coating is located between the conductive gel and the diaphragm.

Further, the conductive gel consists of polymer matrix and conductive material mixed into the polymer matrix.

Further, the polymer matrix includes at least one of nitrile rubber, polyester-based urethane, acrylic resin-modified urethane, polyester-based resin, epoxy resin elastomer, silicone elastomer, acrylate rubber, EPDM rubber, polysulfide rubber, or ethylene-acrylate rubber.

Further, the conductive material is a selection from at least one of metallic material, carbon-based material, or polysilicon material.

Further, the metallic material includes at least one of silver, gold, copper, aluminum, nickel, vanadium, indium, or palladium.

Further, the carbon-based material includes at least one of carbon black, graphene, or carbon nanotubes.

Further, the conductive material includes at least one combination of silver and gold, gold and copper, silver and copper, silver and nickel, silver and vanadium, silver and indium, or silver and palladium.

Further, the conductive member includes a first portion fixed with the frame, a second portion extending in a direction close to the at least two voice coils from the first portion, and a third portion extending in a direction close to the diaphragm from the second portion and fixed with the diaphragm, the first portion is connected to an external electrical circuit and the third portion is connected to the conductive gel.

Further, the at least two voice coils include a first voice coil and a second voice coil, the first voice coil and the second voice coil are nested with each other, the magnetic circuit system includes a lower plate fixed with the frame, a main magnet fixed with the lower plate, a first auxiliary magnet surrounding the main magnet for forming a first magnetic gap, and a second auxiliary magnet surrounding the first auxiliary magnet for forming a second magnetic gap, the first voice coil is fixed with the diaphragm and inserted in the first magnetic gap, the second voice coil is fixed with the diaphragm and inserted in the second magnetic gap.

Further, the at least two voice coils are arranged side by side, the magnetic circuit system includes a lower plate fixed with the frame, at least two center magnets fixed with the lower plate, and a side magnet surrounding the at least two center magnets for forming a third magnetic gap, the at least two voice coils are fixed with the diaphragm and inserted in the third magnetic gap.

Further, a side of the upper plate away from the auxiliary magnet is fixed with the second frame.

Further, the first vibration system further includes a first elastic member fixed with the first frame and a side of the first voice coil close to the first diaphragm respectively, the first diaphragm is fixed with a side of the first elastic member away from the second voice coil.

Further, the second vibration system further includes an elastic supporting assembly and a skeleton in a ring shape, one end of the elastic supporting assembly is fixed with the second frame, the other end of the elastic supporting assembly is fixed with an outer peripheral edge of the skeleton, an inner peripheral edge of the skeleton is fixed with a side of the second voice coil close to the second diaphragm.

Further, the elastic supporting assembly includes a second elastic member and an auxiliary diaphragm, an end of the second elastic member is fixed with the second frame, the other end of the second elastic member is fixed with the outer peripheral edge of the skeleton, the auxiliary diaphragm is fixed with a side of the second elastic member away from the second frame.

Further, the second diaphragm includes an outer suspension, an inner suspension spaced apart from the outer suspension, and a fixing portion extending from an inner peripheral edge of the inner suspension, the inner suspension and the outer suspension are in ring shapes, an inner peripheral edge of the outer suspension is fixed with the second frame, an inner peripheral edge of the outer suspension and an outer peripheral edge of the inner suspension are fixed with the skeleton respectively, a side of the fixing portion close to the magnetic circuit system is fixed with a side of the center auxiliary magnet away from the main pole plate.

Further, a magnetization direction of the main magnet is parallel to a vibration direction of the first diaphragm, the magnetization direction of the auxiliary magnet, the center auxiliary magnet and the center main magnet is parallel and opposite to that of the main magnet.

### BRIEF DESCRIPTION OF THE DRAWINGS

In order to explain the technical solutions of the embodiments of the present disclosure more clearly, accompanying drawings used to describe the embodiments are briefly introduced below. It is evident that the drawings in the following description are only concerned with some embodiments of the present disclosure. For those skilled in the art, in a case where no inventive effort is made, other drawings may be obtained based on these drawings.

FIG. 1 is an isometric view of a speaker with a magnetic circuit system removed in accordance with a first embodiment;

FIG. 2 is an isometric view of a speaker with a magnetic circuit system removed in accordance with a second embodiment;

FIG. 3 is an explode view of the speaker in accordance with the first embodiment;

FIG. 4 is an explode view of the speaker in accordance with the second embodiment.

### DESCRIPTION OF THE EMBODIMENTS

The present disclosure will be further illustrated with reference to the accompanying drawings. It shall be noted that the elements of similar structures or functions are represented by like reference numerals throughout the figures. The embodiments described herein are not intended as an exhaustive illustration or description of various other embodiments or as a limitation on the scope of the claims or the scope of some other embodiments that are apparent to one of ordinary skills in the art in view of the embodiments described in the Application. In addition, an illustrated embodiment need not have all the aspects or advantages shown.

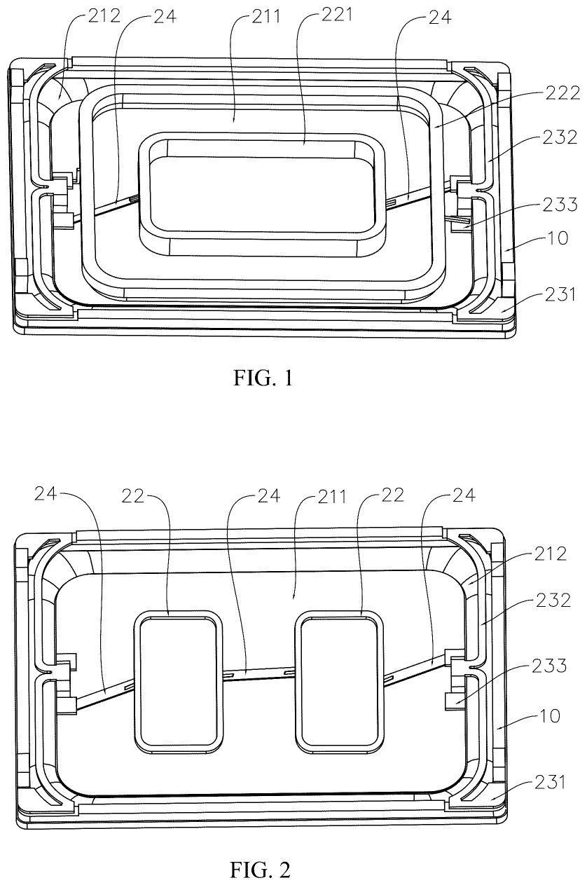

As shown in the FIGS. 1-4. The present invention discloses a speaker 100, which includes a frame 10, a vibration system 20 fixed with the frame 10, and a magnetic circuit system 30 fixed with the frame 10 and driving the vibration system 20 to vibrate and sound. The vibration system 20 includes a diaphragm 21 fixed with the frame 10, at least two voice coils 22 driving the diaphragm 21 to vibrate and sound, and a conductive member 23 electrically connected with the at least two voice coils 22. The at least two voice coils 22 are fixed with the diaphragm 21, the at least two voice coils 22 is connected to an external circuit via the conductive member 23. The diaphragm 21 driven by the at least two voice coils 22 could increase the BL value and vibration sensitivity of the speaker, could effectively improve the performance of the speaker.

As shown in the FIGS. 1-4. The diaphragm 21 includes a suspension 212 fixed with the frame 10 and a dome 211 connected to the suspension 212, the at least two voice coils 22 and the conductive member 23 are fixed with the dome 211.

The at least two voice coils 22 are connected to each other via a conductive gel 24 and/or the at least two voice coils 22 are connected to the conductive member 23 by the conductive gel 24, the conductive gel 24 is affixed to the diaphragm 21, and an insulating coating is located between the conductive gel 24 and the diaphragm 21. Thus, the volume of the magnetic circuit system 30 could be saved and the stability of the electrical connection of the at least two voice coils 22 could be enhanced, and the acoustic performance of the speaker 100 could also be improved.

The arrangement of the at least two voice coils 22 could be set side by side or nested.

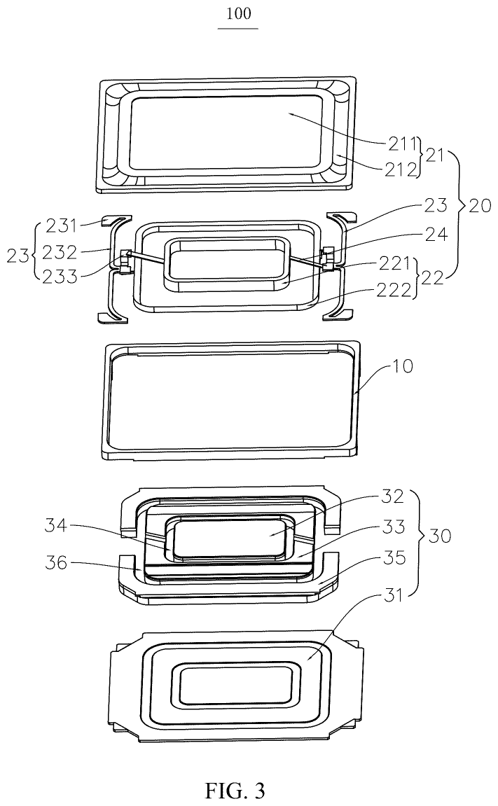

As shown in the FIG. 1 and FIG. 3, the speaker 100 is provided by a first embodiment. In the first embodiment the at least two voice coils 22 include a first voice coil 221 and a second voice coil 222, the first voice coil 221 and the second voice coil 222 are nested with each other. The magnetic circuit system 30 includes a lower plate 31 fixed with the frame 10, a main magnet 32 fixed with the lower plate 31, a first auxiliary magnet 33 surrounding the main magnet 32 for forming a first magnetic gap 34, and a second auxiliary magnet 35 surrounding the first auxiliary magnet 33 for forming a second magnetic gap 36, the first voice coil 221 is fixed with the diaphragm 21 and inserted in the first magnetic gap 34, the second voice coil 222 is fixed with the diaphragm 21 and inserted in the second magnetic gap 36. The first voice coil 221 is closer to the conductive member 23 than the second voice coil 222, therefore in this embodiment, the second voice coil 222 and the conductive member 23 could be connected by a conductive gel 24, instead of conventional connection by a voice coil wire, thereby, the risk of breakage by the excessively long voice coil could be avoided, the stability of the electrical connection of the at least two voice coils could be enhanced. In other embodiment, the first voice coil 221 and the second voice coil 222 are connected by the conductive gel, and then the first voice coil 221 is connected with the conductive member 23, therefore, a series electrical connection is realized between the first voice coil 221 and the second voice coil 222, and the conventional FPC could be replaced and the volume of the magnetic circuit system 30 could be saved. The conductive gel 24 is affixed to the dome 211 of the diaphragm 21, an insulating coating is located between the conductive gel 24 and the dome 211 to realize external insulation to avoid short-circuiting of the voice coil 22 and to ensure the stability of the electrical connection.

It is to be noted that, an amount of the at least two voice coils 22 may be more than three, all of the voice coils 22 are nested with each other which could improve the driving force of the voice coil. The at least two voice coils are connected with each other by the conductive gel 24 for realizing the connection between the at least two voice coils and/or the at least two voice coils are connected with the conductive member 23 by the conductive gel 24 for realizing the connection between the at least two voice coils and the conductive member 23, which are within the scope of protection of the present invention.

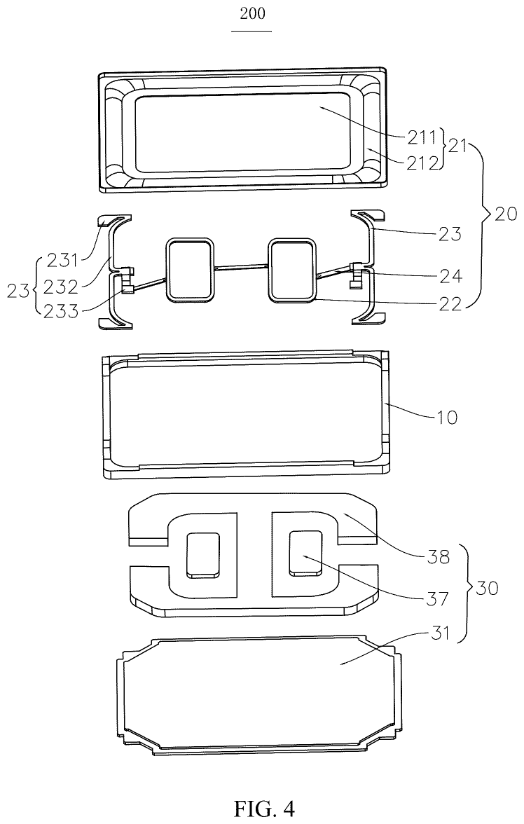

As shown in the FIG. 2 and FIG. 4 the speaker 100 is provided by a second embodiment. The at least two voice coils 22 are arranged side by side. The magnetic circuit system 30 includes a lower plate 31 fixed with the frame 10, at least two center magnets 37 fixed with the lower plate 31, a side magnet 38 surrounding the at least two center magnets 37 for forming a third magnetic gap, the at least two voice coils are fixed with the diaphragm 21 and inserted in the third magnetic gap. In this embodiment, the conductive gel 24 can be used to connect the at least two voice coils 22, while the conductive gel 24 is used to connect the at least two voice coils 22 and the conductive member 23 to realize the series connection between the at least two voice coils 22; or only the conductive gel 24 is used to connect the at least two voice coils 22 and the conductive member 23 respectively to realize the parallel electrical connection between the at least two voice coils 22, so that individual voice coils can be individually adjusted according to the actual needs of the situation of the driving force. Alternatively, only at least two voice coils 22 are connected via the conductive gel 24 to realize an electrical connection between the at least two of voice coils 22, and then at last two the voice coils 22 are connected to the conductive member 23 respectively. Of course, other cases in which the at least two voice coils 22 are connected to each other and/or the at least two voice coils 22 and the conductive member 23 are connected to each other and/or the at least two voice coils 22 and the conductive member 23 by means of the conductive gel 24 are within the scope of protection of the present invention.

As shown in the FIGS. 1-4, the conductive member 23 includes a first portion 231 fixed with the frame 10, a second portion 232 extending in a direction close to the at least two voice coils 22 from the first portion 231, and a third portion 233 extending in a direction close to the diaphragm 21 from the second portion 232 and fixed with the diaphragm 21, the first portion 231 is connected to an external electrical circuit and the third portion 233 is connected to the conductive gel 24. One end of the conductive member 23 is connected with the external electrical circuit, the other end of the conductive member 23 is connected with the conductive gel 24 affixed to the diaphragm 21, which could realize the electrical connection of the at least two voice coils 22. The third portion 233 of the conductive member 23 and the at least two voice coils are fixed with the diaphragm 21 and spaced apart. Thereby, the stability of the electrical connection of the at least two voice coils 22 could still be realized even during vibrating to sound of the speaker.

The conductive gel 24 consists of polymer matrix and conductive material mixed into the polymer matrix. The conductive material has conductive properties that enable the conductivity of the conductive gel 24 to be realized and provides for the realization of the low resistance properties of the conductive gel 24.

The polymer matrix includes at least one of nitrile rubber, polyester-based urethane, acrylic resin-modified urethane, polyester-based resin, epoxy resin elastomer, silicone elastomer, acrylate rubber, EPDM rubber, polysulfide rubber, or ethylene-acrylate rubber. The conductive material is a selection from at least one of metallic material, carbon-based material, or polysilicon material. As the combination of the above materials, the conductive gel 24 is made to have good flexibility and elasticity, which could not only make the conductive gel 24 not easy to break so as to ensure the stability of the electrical connection of the voice coil 22, but also make the conductive gel 24 better able to cooperate with the dome 211 to ensure vibration consistency.

Further, the metallic material includes at least one of silver, gold, copper, aluminum, nickel, vanadium, indium, or palladium. The carbon-based material includes at least one of carbon black, graphene, or carbon nanotubes. The conductive material includes at least one combination of silver and gold, gold and copper, silver and copper, silver and nickel, silver and vanadium, silver and indium, or silver and palladium. The conductive properties of the conductive gel 24 could thus be improved to ensure the driveability of the at least two voice coils 22.

Compared with the related art, the present invention includes a frame, a vibration system fixed with the frame, and a magnetic circuit system driving the vibration system to vibrate and sound. The vibration system includes a diaphragm fixed with the frame, at least two voice coils driving the diaphragm to vibrate and sound, and a conductive member, the at least two voice coils are connected to each other via a conductive gel and/or the at least two voice coils are connected to the conductive member via the conductive gel, the conductive gel is affixed to the diaphragm, and an insulating coating is located between the conductive gel and the diaphragm. As the conductive gel is provided to realize the electrical connection between the at least two voice coils and/or between the at least two voice coils and the conductive member, the traditional connection method of utilizing voice coil wire to connect to the FPC could be replaced. Thus, the volume of the magnetic circuit system could be saved, the stability of the electrical connection of the at least two voice coils could be enhanced, and the acoustic performance of the speaker 100 could also be improved.

It should be appreciated by those skilled in the art that various modifications are possible without departing from the spirit or scope of the present invention. The embodiments illustrated above should not be interpreted as limits to the present invention, and the scope of the invention is to be determined by reference to the claims that follow.

What is claimed is:

1. A speaker comprising:
a frame;
a vibration system fixed with the frame, comprising a diaphragm fixed with the frame, at least two voice coils driving the diaphragm to vibrate and sound, and a conductive member; and
a magnetic circuit system driving the vibration system to vibrate and sound; wherein
the at least two voice coils are connected to each other via a conductive gel and/or the at least two voice coils are connected to the conductive member via the conductive gel, the conductive gel is affixed to the diaphragm, and an insulating coating is located between the conductive gel and the diaphragm.

2. The speaker as described in claim 1, wherein the conductive gel consists of polymer matrix and conductive material mixed into the polymer matrix.

3. The speaker as described in claim 2, wherein the polymer matrix comprises at least one of nitrile rubber, polyester-based urethane, acrylic resin-modified urethane, polyester-based resin, epoxy resin elastomer, silicone elastomer, acrylate rubber, EPDM rubber, polysulfide rubber, or ethylene-acrylate rubber.

4. The speaker as described in claim 2, wherein the conductive material is a selection from at least one of metallic material, carbon-based material, or polysilicon material.

5. The speaker as described in claim 4, wherein the metallic material comprises at least one of silver, gold, copper, aluminum, nickel, vanadium, indium, or palladium.

6. The speaker as described in claim 4, wherein the carbon-based material comprises at least one of carbon black, graphene, or carbon nanotubes.

7. The speaker as described in claim 5, wherein the conductive material comprises at least one combination of silver and gold, gold and copper, silver and copper, silver and nickel, silver and vanadium, silver and indium, or silver and palladium.

8. The speaker as described in claim 1, wherein the conductive member comprises a first portion fixed with the frame, a second portion extending in a direction close to the at least two voice coils from the first portion, and a third portion extending in a direction close to the diaphragm from the second portion and fixed with the diaphragm, the first portion is connected to an external electrical circuit and the third portion is connected to the conductive gel.

9. The speaker as described in claim 1, wherein the at least two voice coils comprise a first voice coil and a second voice coil, the first voice coil and the second voice coil are nested with each other, the magnetic circuit system comprises a lower plate fixed with the frame, a main magnet fixed with the lower plate, a first auxiliary magnet surrounding the main magnet for forming a first magnetic gap, and a second auxiliary magnet surrounding the first auxiliary magnet for forming a second magnetic gap, the first voice coil is fixed with the diaphragm and inserted in the first magnetic gap, the second voice coil is fixed with the diaphragm and inserted in the second magnetic gap.

10. The speaker as described in claim 1, wherein the at least two voice coils are arranged side by side, the magnetic circuit system comprises a lower plate fixed with the frame, at least two center magnets fixed with the lower plate, and a side magnet surrounding the at least two center magnets for forming a third magnetic gap, the at least two voice coils are fixed with the diaphragm and inserted in the third magnetic gap.
